(19) United States
(12) Patent Application Publication
(10) Pub. No.: US 2016/0349817 A1
(43) Pub. Date: Dec. 1, 2016

(54) POWER PROTECTED MEMORY WITH CENTRALIZED STORAGE

(71) Applicant: Intel Corporation, Santa Clara, CA (US)

(72) Inventors: Mohan J. Kumar, Aloha, OR (US); Murugasamy K. Nachimuthu, Beaverton, OR (US); George Vergis, Portland, OR (US)

(21) Appl. No.: 14/998,141

(22) Filed: Dec. 26, 2015

Related U.S. Application Data
(60) Provisional application No. 62/168,506, filed on May 29, 2015.

(51) Int. Cl. G06F 1/30; G06F 3/06

(52) U.S. Cl. CPC G06F 1/30; G06F 3/0625; G06F 3/0647; G06F 3/0679

(57) ABSTRACT

Power protecting a memory subsystem with a centralized storage device. A centralized backup energy source provides power temporarily when power supply power is interrupted. In response to detecting interruption of power supply power, a controller selectively connects multiple selected memory devices to a centralized SATA (serial advanced technology attachment) storage device to transfer contents of the selected memory devices to the storage device while powered by the backup energy source.

### RELATED APPLICATIONS

This patent application is a nonprovisional application based on U.S. Provisional Application No. 62/168,506, filed May 29, 2015. This application claims the benefit of priority of that provisional application. The provisional application is hereby incorporated by reference.

The present patent application is related to the following patent application: patent application Ser. No. ______ [P84941], entitled “MEMORY DEVICE SPECIFIC SELF-REFRESH ENTRY AND EXIT,” filed concurrently herewith.

### FIELD

Embodiments of the invention are generally related to memory subsystems, and more particularly to power protected memory subsystems.

### COPYRIGHT NOTICE/PERMISSION

Portions of the disclosure of this patent document may contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright © 2015, Intel Corporation, All Rights Reserved.

### BACKGROUND

Memory subsystems store code and data for use by the processor to execute the functions of a computing device. Memory subsystems traditionally have volatile memory resources, which are memory devices whose state is indefinite or indeterminate if power is interrupted to the device. Thus, volatile memory is contrasted with persistent or nonvolatile storage, which has a determinate state even if power is interrupted to the device. The difference is based on the memory technology used to implement the memory, and volatile memory resources traditionally have faster access times, and denser capacities (having more bits per unit area). While there is research into technology that may eventually provide persistent storage having capacities and access speeds comparable with current volatile memory, the cost and familiarity of current volatile memories are very attractive features.

The primary downside of volatile memory is that its data is lost when power is interrupted. There are systems that provide battery-backed memory that provides battery power to continue to refresh the volatile memory to prevent it from losing state if primary power is interrupted. There are also systems in which memory devices are placed on one side of a DIMM (dual inline memory module), and persistent storage is placed on the other side of the DIMM. The system is powered by a super capacitor, or a capacitor that holds enough charge to enable the system to transfer the contents of the volatile memory devices to the persistent storage device(s) if power is interrupted to the memory subsystem. While such systems can prevent or at least reduce loss of data in the event of a loss of power, they take up a significant amount of system space, and cut the DIMM capacity in half. Thus, such systems are impractical in computing devices with more stringent space constraints. Additionally, lost memory capacity results in either having less memory, or costly solutions to add more hardware.

Currently available memory protection includes Type 1 NVDIMM (nonvolatile DIMM), which is also referred to in industry as NVDIMM-n. Such systems are energy backed byte accessible persistent memory. Traditional designs contain DRAM (dynamic random access memory) devices on one side of the DIMM and one or more NAND flash devices on the other side of the DIMM. Such NVDIMMs are attached to a super capacitor through a pigtail connector, and the computing platform supplies power (e.g., 12V) to the super capacitor to charge it during normal operation. When the platform power goes down, the capacitor supplies power to the DIMM and the DIMM controller to allow it to save the DRAM contents to the NAND device on the back of the DIMM. In a traditional system, each super capacitor takes one SATA (serial advanced technology attachment) drive bay of real estate.

In addition to the significant amount of real estate required, traditional designs are three to four times the cost of standard DRAM memory devices. Thus, such memory protection systems do not find widespread adoption in products due to the high cost and the real estate area required to support the super capacitors in the platform. Additionally, current NVDIMM capacity is limited due to the real estate occupied by the protection devices within the DIMM.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, and/or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of a power protected memory system with centralized storage.

FIG. 2 is a block diagram of an embodiment of a power protected memory system that selectively transfers memory contents to storage on power failure.

FIG. 3 is a block diagram of an embodiment of a power protected memory system platform.

FIG. 4 is a block diagram of an embodiment of a DIMM (dual inline memory module) for a power protected memory system with centralized storage.

FIG. 5 is a block diagram of an embodiment of a power protected memory system with consolidated storage not on the NVDIMM (nonvolatile DIMM).

FIG. 6 is a flow diagram of an embodiment of a process for backing up volatile memory in response to an interruption of power supply power.

FIG. 7 is a block diagram of an embodiment of a computing system in which a power protected memory system can be implemented.

FIG. 8 is a block diagram of an embodiment of a mobile device in which a power protected memory system can be implemented.

Descriptions of certain details and implementations follow, including a description of the figures, which may depict some or all of the embodiments described below, as well as discussing other potential embodiments or implementations of the inventive concepts presented herein.

### DETAILED DESCRIPTION

As described herein, a power protection controller enables power protecting a memory subsystem with a centralized storage device. A centralized backup energy source provides power temporarily when power supply power is interrupted. In response to detecting interruption of power supply power, the controller selectively connects multiple selected memory devices to a centralized SATA (serial advanced technology attachment) storage device to transfer contents of the selected memory devices to the storage device while powered by the backup energy source. The centralized storage device is located on a computing system platform separately from the memory subsystem. In one embodiment, the selected memory devices are connected in sequence to the storage device.

The centralized storage with the controller described herein enables Type 1 compliant NVDIMM (nonvolatile dual inline memory module) designs. A Type 1 NVDIMM refers to a memory module with energy backed, byte accessible persistent memory. As described herein, an NVDIMM can have standard DIMM capacity and reduced footprint on the computing system platform relative to traditional NVDIMM approaches. It will be understood that super capacitor (which may be referred to herein as a “super-cap”) footprint does not increase linearly with increased energy storage capacity. Thus, double the capacitor capacity does not double the capacitor in size. Therefore, a protection system with a centralized larger capacity super-cap can provide an overall reduction in protection system size. Additionally, centralized persistent storage can allow the DIMMs to have standard memory device (such as DRAM (dynamic random access memory)) configurations, which can allow for NVDIMMs that have standard DIMM capacities. In one embodiment, the centralized storage can be implemented in SATA storage that would already be present in the system (e.g., by setting aside a protection partition equal to the size of volatile memory desired to be backed up). The amount of memory to be backed up can be programmable.

When power supply power goes down or is lost or interrupted, a protection controller can selectively connect the memory portion(s) selected for backup, and transfer their contents while the super-cap charges the memory subsystem (and the storage used for persistent storage of the memory contents) during the data transfer. In one embodiment, the backup storage is a dedicated SATA SSD (solid state storage) on the platform. In one embodiment, the backup storage is part of SATA storage already available on the platform. In one embodiment, the SATA storage is a component added to and dedicated to the memory subsystem. In one embodiment, the SATA storage is a component on a part of the hardware platform separate from the memory subsystem.

While descriptions below provide examples with respect to DIMMs, it will be understood that similar functionality can be implemented in whatever type of system includes memory devices that share a control bus and a data bus and/or share power backup. Thus, the use of a specific “memory module” is not necessary. Traditional DIMMs include RDIMMs (registered DIMMs) and LRDIMMs (load reduced DIMMs) to try to reduce the loading of the DIMM on a computing platform. The reduced loading can improve signal integrity of memory access and enable higher bandwidth transfers. On an LRDIMM, the data bus and control bus (e.g., command/address (C/A) signal lines) are fully buffered, where the buffers re-time and re-drive the memory bus to and from the host (e.g., an associated memory controller). The buffers isolate the internal buses of the memory device from the host. On an RDIMM, the data bus connects directly to the host memory controller. The control bus (e.g., the C/A bus) is re-timed and re-driven. Thus, the inputs are considered to be registered on the clock edge. In place of a data buffer, RDIMMs traditionally use passive multiplexers to isolate the internal bus on the memory devices from the host controller. In one embodiment, an RDIMM can be used for an NVDIMM implementation. Traditional DIMM implementations have a 72-pin data bus interface, which causes too much loading to implement an NVDIMM. LRDIMMs are traditionally used because they buffer the bus.

In one embodiment, the power protection controller is a controller on each DIMM. In one embodiment, the controller is or includes an RCD (registered clock driver, which can also be referred to as a registering clock driver). It will be understood that the controller represented by an RCD is different from a host controller or memory controller of a computing device in which the system is incorporated. Likewise, the controller of an RCD is different from an on-chip or on-die controller that is included on the memory devices. A registered clock driver receives information from the host (such as a memory controller) and buffers the signals from the host to the various memory devices. If all memory devices were directly connected to the host, the loading on the signal lines would degrade high speed signaling capability. By buffering the input signals from the host, the host only sees the load of the RCD, which can then control the timing and signaling to the memory devices. In one embodiment, the RCD is a controller on a DIMM to control signaling to the various memory devices.

In one embodiment, the controller is coupled to a programmable SATA multiplexer, which can selectively connect multiple DRAMs or other memory devices to one or more SATA storage devices (e.g., there can be more than one storage pathway available to transfer data). In one embodiment, the controller couples to the memory devices via an I²C (inter-integrated circuit, sometimes referred to as I2C) interface. The controller is coupled to the central super-cap logic to receive indication of when power supply power is interrupted. The controller includes logic to control a programming interface to implement the power protected memory functionality. The programming interface can couple to the memory devices to select them for transfer. In one embodiment, the programming interface enables the controller to cause the memory devices to select a backup port for communication. In one embodiment, the programming interface connects to the programmable SATA multiplexer to select how and when each memory device(s) connects. The controller can be referred to as a PPM-SPC (power protected memory storage and power controller), or simply an SPC.

Reference to memory devices can apply to different memory types. Memory devices generally refer to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR3 (dual data rate version 3, original release by JEDEC (Joint Electronic Device Engineering Council) on Jun. 27, 2007, currently on release 21), DDR4 (DDR version 4, initial specification published in September 2012 by JEDEC), DDR4E (DDR version 4, extended, currently in discussion by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (currently in discussion by JEDEC), HBM2 (HBM version 2), currently in discussion by JEDEC), and/or others, and technologies based on derivatives or extensions of such specifications.

Descriptions herein referring to a “DRAM” can apply to any memory device that allows random access. The memory device or DRAM can refer to the die itself and/or to a packaged memory product.

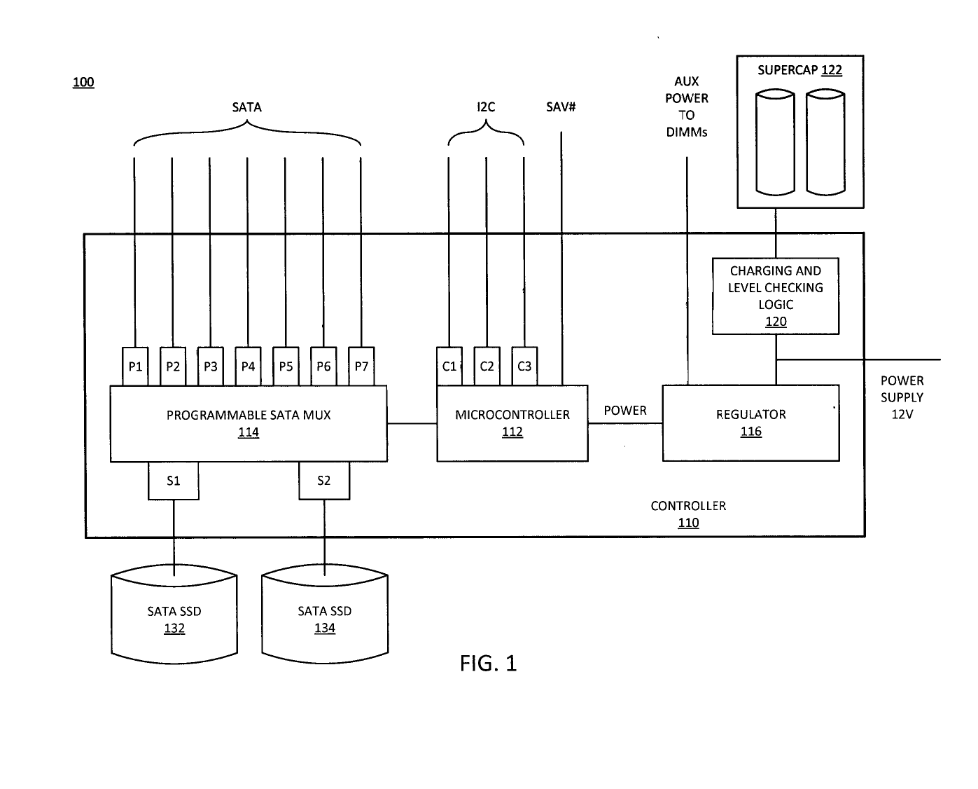

FIG. 1 is a block diagram of an embodiment of a power protected memory system with centralized storage. In one embodiment, system 100 illustrates a controller architecture to provide NVDIMM functionality or an equivalent or derivative of NVDIMM. For purposes of simplicity herein, NVDIMM functionality refers to the capability to back up volatile memory devices. Controller 110 represents an SPC or PPM-SPC.

In one embodiment, controller 110 includes microcontroller 112, programmable multiplexer (mux) logic 114, super capacitor charging and charging level check logic 120, regulator 116, and I²C controllers or other communication controllers (which can be part of microcontroller 112). System 100 includes centralized super capacitor (super-cap) 122 to provide power when platform power from a power supply is interrupted. The power supply is illustrated as the line coming into controller 110 that is labeled “power supply 12V.” While specifically identified as a 12V supply, it will be understood that the power supply voltage could be any voltage used in a computing platform to charge a backup energy source. Controller 110 can charge super-cap 122 from the power supply while the power supply power is available. Logic 120 enables controller 110 to charge super-cap 122 and monitor its charge level. Logic 120 can detect when there is an interruption in power supply power, and allow energy from super-cap 122 to flow to regulator 116. Thus, super-cap 122 provides power in place of the power supply when power is interrupted to system 100.

Regulator 116 can provide power to controller 110 and to connected DIMMs. Regulator 116 can provide such power based on power supply power when available, and based on energy from super-cap 122 when power supply power is not available, or falls below a threshold input used for regulation. The power supply power is power provided by a hardware platform in which system 100 is incorporated. As illustrated, regulator 116 provides power to microcontroller 112 (and to the rest of controller 110), as well as providing auxiliary power to DIMMs. In one embodiment, the auxiliary power to the DIMMs is only used by the DIMMs when power supply power is interrupted. While not specifically shown in system 100, SATA drives 132 and 134 can likewise be powered from power supply power when available, and are powered from super-cap 122 when power supply power is interrupted. In one embodiment, SATA drives 132 and 134 are charged directly from super-cap 122, and not through regulator 116. In one embodiment, regulator 116 powers the SATA drives.

When the hardware platform, in which system 100 is a part, provides power via power supply 12V, controller 110 and microcontroller 112 can be powered by the platform. In one embodiment, microcontroller 112 monitors the charging level of super-cap 122. In one embodiment, the platform BIOS (basic input/output system) can check the super capacitor charge level by reading microcontroller 112 through an I²C bus or other suitable communication connection. In one embodiment, the BIOS can check the charging level and report to the host OS (operating system) that controls the platform operation. The BIOS can report to the host OS through an ACPI interface (advanced configuration and power interface) mechanism to indicate to the OS if the NVDIMM has enough charge to save the data on power failure.

In one embodiment, the system platform for system 100 provides a power supply monitoring mechanism, by which controller 110 receives an indication of whether the power supply power is available. Microcontroller 112 can control the operation of logic 120 based on whether there is system power. In one embodiment, microcontroller 112 receives a SAV# signal asserted from the host platform when power supply power fails. In one embodiment, if the platform generates a SAV# signal assertion, the PPM (power protected memory) DIMMs that receive the signal can enter self-refresh mode. In one embodiment, when controller 110 (e.g., a PPM-SPC) receives the SAV# assertion, microcontroller 112 can select a DIMM port (e.g., P[1:7]) in SATA mux 114. Microcontroller 112 can also inform the selected PPM DIMM through I²C (e.g., C[1:3]) to start saving its memory contents. In one embodiment, controller 110 includes one I²C port per memory channel (e.g., C1, C2, C3). Other configurations are possible with different numbers of I²C ports, different numbers of channels, or a combination. In one embodiment, controller 110 includes a LBA (logical block address) number of an SSD to store to. In one embodiment, the PPM DIMM saves the memory contents to a SATA drive, e.g., SATA SSD 132 or SATA SSD 134, connected to S1 and S2, respectively, of SATA mux 114. In one embodiment, controller 110 polls the PPM DIMM to determine if the transfer is completed.

In one embodiment, programmable SATA mux 114 allows mapping of DIMM channels to SATA drives 132 and 134 in a flexible way. When SATA mux 114 includes flexible mux logic, it can be programmed or configured based on how much data there is to transfer from the volatile memory, and how much time it will take to transfer. Additionally, in one embodiment, controller 112 can control the operation of SATA mux 114 based on how much time is left to transfer (e.g., based on determining the count of a timer started when power supply power was detected as interrupted). Thus, mux 114 can select DIMMs based on how much data there is to transfer and how much time there is to transfer it. As illustrated, SATA mux 114 includes 7 channels. There can be multiple DIMMs per channel. The size of the bus can determine how many devices can transfer concurrently. While SATA storage devices 132 and 134 are illustrated, in general there can be a single storage device, or two or more devices. In one embodiment, SATA storage devices 132 and 134 include storage resources that are dedicated to memory backup, such as configured to be part of a PPM system.

SATA storage devices 132 and 134 include centralized storage resources, rather than a storage resource available for only a single DIMM. Wherever located, multiple DIMMs can store data to the same storage resources in system 100. In one embodiment, SATA storage devices 132 and 134 include storage resources that are part of general purpose storage in the computing system or hardware platform in which system 100 is incorporated. In one embodiment, SATA storage devices 132 and 134 include nonvolatile storage resources built into a memory subsystem. In one embodiment, SATA storage devices 132 and 134 include nonvolatile storage resources outside of the memory subsystem.

Once the transfer is completed from volatile memory to nonvolatile storage, in one embodiment, controller 110 informs the selected power protected DIMM(s) to power down. In one embodiment, only one PPM DIMM is powered up at a time, and controller 110 can select each DIMM in sequence to start saving its contents. The process can continue until PPM DIMM contents are saved. In one embodiment, microcontroller 112 can be programmed during boot which DIMMs to power protect and which DIMMs will not be saved. Thus, system can provide flexibility to allow for optimizing the storage as well as the power and time spent transferring contents. Programming in the host OS can save more critical elements to the DIMMs selected for backup, assuming not all memory resources will be backed up.

As illustrated in system 100, a PPM memory system can include super-cap 122 as a backup energy source coupled in parallel with the platform power supply. Super-cap 122 can provide a temporary source of energy when power from the platform power supply is interrupted. In one embodiment, super-cap 122 is a centralized energy resource, which can provide backup power to multiple DIMMs, instead of being to a single DIMM. System 100 includes one or more SATA storage devices (such as 132 and 134). Controller 110 interfaces with a memory network of volatile memory devices. Controller 110 can detect that the platform power supply is interrupted, which would otherwise power the memory devices. In response to detection of the power interruption, controller 110 can selectively connect the memory devices to storage devices 132 and/or 134 to transfer contents of selected memory devices to the nonvolatile storage.

In one embodiment, SATA mux 114 can enable controller 110 to selectively connect memory devices in turn to SATA storage devices 132 and 134. Thus, for example, each memory device may be provided a window of time dedicated to transferring its contents to the centralized storage. In one embodiment, the order of selection is predetermined based on system configuration. For example, the system can be configured beforehand to identify which memory resources hold the most critical data to back up, and order the backup based on such a configuration. Such a configuration allows the host OS to store data in different memory locations based on whether it will be backed up or not.

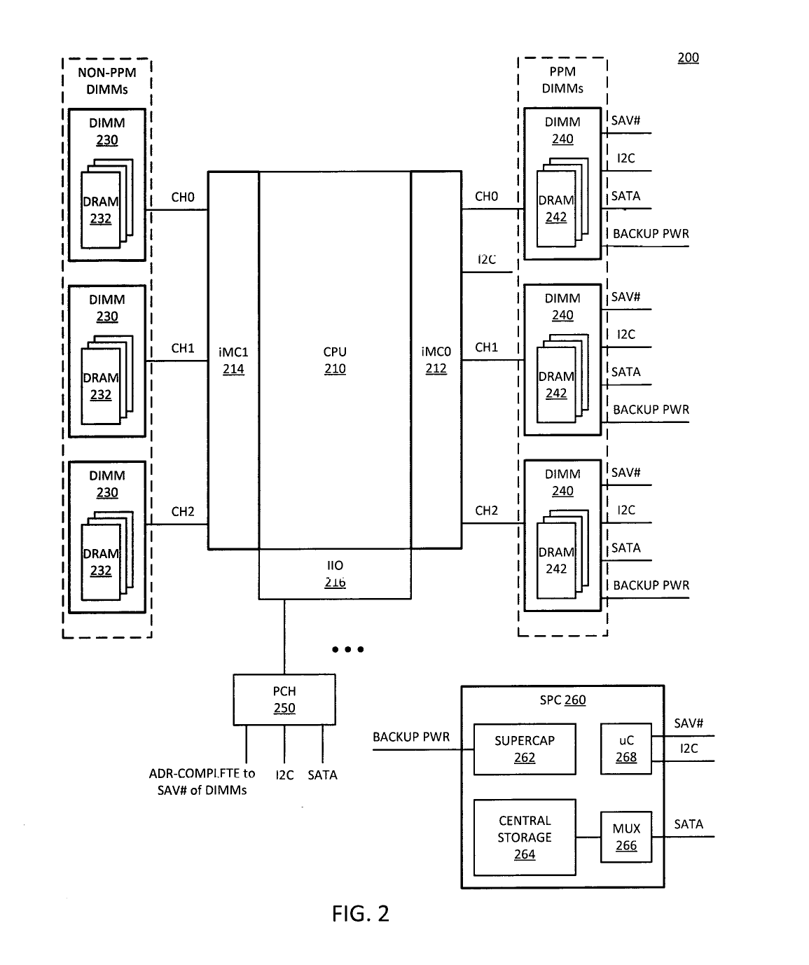

FIG. 2 is a block diagram of an embodiment of a power protected memory system that selectively transfers memory contents to storage on power failure. System 200 provides one example of an embodiment of a PPM system in accordance with system 100 of FIG. 1. System 200 illustrates host platform components CPU 210, iMC0 212, iMC1 214, IIO 216, and PCH 250. In one embodiment, system 200 includes PPM DIMMs (DIMMs 240) to be saved on power supply power interruption, and DRAM DIMMs or non-PPM DIMMs (DIMMs 230), which will not be saved to nonvolatile storage. Thus, both NVDIMM and standard DIMM resources can be used in the same system.

CPU (central processing unit) 210 represents central processing hardware for system 200, and executes the host operating system (OS) for system 200. CPU 210 generally controls the flow of operation for system 200. While power supply power for the platform (not specifically shown) is available, CPU 210 controls the access to memory resources in system 200. In one embodiment, SPC 260 represents a power protection controller such as controller 110 of system 100, which can control the storing of memory contents to nonvolatile storage based on backup power.

Under normal power operation, CPU 210 accesses memory resources for read and/or write via memory controller circuitry. In one embodiment, system 200 includes two memory controller circuits, illustrated as iMCs (integrated memory controllers) 212 and 214. While the memory controllers of system 200 are specifically illustrated as integrated, referring to integrated onto a chip or a substrate with CPU 210, discrete memory controllers could alternatively be used. Integration of the memory controllers could refer to integrating memory controller circuitry directly onto a processor die. Integration of the memory controller could refer to integrating memory controller circuitry onto an SoC (system on a chip) on which the CPU die is disposed.

In one embodiment, each memory controller 212 and 214 include three memory channels (CH0, CH1, and CH2). The three channels shown are for purposes of illustration only, and in one embodiment the memory controllers can support more or fewer channels. In one embodiment, a single memory controller connects to both power protected and non-protected memory resources. Each memory controller can separately control access to the memory resources on the separate channels. As illustrated, iMC1 214 is connected to non-protected DIMMs 230. DIMMs 230 include memory resources as illustrated by DRAMs 232. As also illustrated, iMC0 212 is connected to protected DIMMs 240. DIM Ms 240 include memory resources as illustrated by DRAMs 242. System 200 illustrated central super-cap 262 and central backup storage 264, illustrated as part of SPC 260. In one embodiment, a single hardware SPC device includes control logic and the super-cap. In one embodiment, a single hardware SPC device includes control logic, the super-cap, and the storage. If SPC 260 does not include super-cap 262 and storage 264, they can still be represented as part of the SPC from the perspective of being part of the protection system and controlled by SPC 260. With centralized energy backup and storage resources, protected DIMMs 240 can include comparable numbers of DRAMs 242 to DRAMs 232 of non-protected DIMMs 230.

In one embodiment, system 200 includes IIO 216, which represents I/O (input/output) circuitry of CPU 210. For example, IIO 216 can be integrated I/O circuitry that interfaces a CPU SoC to PCH (peripheral control hub) 250. PCH 250 represents circuitry to connect CPU 210 to peripheral devices within the computing platform. Peripherals can be or include storage and any device connected via a bus that connects to an external port, such as USB (universal serial bus), user I/O connections, or other peripheral connectors. PCH 250 can connect to sensors and other devices on the hardware platform that provide monitoring and/or other control services to the platform.

In one embodiment, the system platform includes one or more mechanisms to monitor power supply power. In one embodiment, the system includes a CPLD (complex programmable logic device) (not shown) that monitors a power supply signal PS_PWR_GOOD (not shown). While the signal indicates that power is available from the host platform, the CPLD can assert a signal SYS_PWR_OK (not shown) to PCH 250 to indicate that there is still power. In one embodiment, PCH 250 starts a timer and asserts a signal ADR_COMPLETE, which can be connected to the SAV# pin of the PPM DIMMs 240. SAV# can also be coupled as an input to microcontroller (uC) 268 of SPC 260. With such a signal or a similar mechanism, microcontroller 268 can control the selective connection of DRAMs 242 to storage 264 via mux 266, based on whether there is system power and how much energy is available in super-cap 262.

Storage 264 can be any type of nonvolatile storage. For example, storage 264 can be or include NAND memory such as Flash, spinning disk resources, and/or other nonvolatile storage technologies. Nonvolatile storage can include 3-D cross-point memory that are byte addressable, memory that use chalcogenide phase change material (e.g., chalcogenide glass), multi-threshold level NAND flash memory, NOR flash memory, single or multi-level phase change memory (PCM), resistive memory, nanowire memory, ferroelectric transistor random access memory (FeTRAM), magnetoresistive random access memory (MRAM) memory that incorporates memristor technology, or spin transfer torque MRAM (STT-M RAM), or a combination of any of the above, or other non-volatile memory types.

In one embodiment, system 200 includes one I²C controller per I²C system. As illustrated, system 200 includes a single SATA port for a PCH connection and one I²C port for a PCH connection via PCH 250. Other configurations are possible. Additional connections can be made in an alternate embodiment. In one embodiment, SPC 260 accesses storage 264 via PCH 250. In one embodiment, SPC 260 provides I²C control via PCH 250. In one embodiment, SPC 260 can be a device that mounts into a storage bay, and connects to CPU 210 via a storage bus, via PCH 250.

It will be observed that PPM DIMMs 240 illustrate a SAV# port, a SATA port, an I²C port, and backup power port. The connections on the PPM DIMMs correspond to similarly labeled connections controlled by SPC 260. In one embodiment, the DRAM DIMMs or non-PPM DIMMs 230 can be enabled for PPM (e.g., having hardware and logic on-board to implement PPM), but selectively not be utilized as power protected memory resources.

In one embodiment, SPC 260 controls access by memory resources to storage 264 to limit one resource at a time to access the storage for backup. The access control can have differing levels of granularity, depending on system configuration. For example, the memory resources can be or include multiple DRAMs/SDRAMs coupled together in DIMMs or other memory modules. In one embodiment, DRAMs 242 can be memory devices disposed directly on a motherboard or host system platform (e.g., a PCB (printed circuit board) on which CPU 310 is disposed) of a computing device. In one embodiment, the memory devices can be organized into memory modules. In one embodiment, the memory modules represent DIMMs, as illustrated for example in system 200. In one embodiment, DIMMs 230 and/or DIMMs 240 represent other organization of multiple memory devices to share at least a portion of access or control circuitry, which can be a separate circuit, a separate device, or a separate board from the host system platform.

In one embodiment, SPC 260 controls backup access from all memory devices or volatile memory resources in a system (not what is shown in system 200). In one embodiment, as illustrated in system 200, SPC 260 can control backup of selected ones of the memory resources. In one embodiment, SPC 260 controls backup access one memory resource at a time. In such an implementation, the access can be controlled to selectively connect DRAMs 242 on a per memory controller basis (assuming more than one memory controller includes DRAMs to back up). Alternatively, the access can be controller to selectively connect DRAMs 242 on a per DIMM basis. Alternatively, the access can be controller to selectively connect DRAMs 242 on a per channel basis.

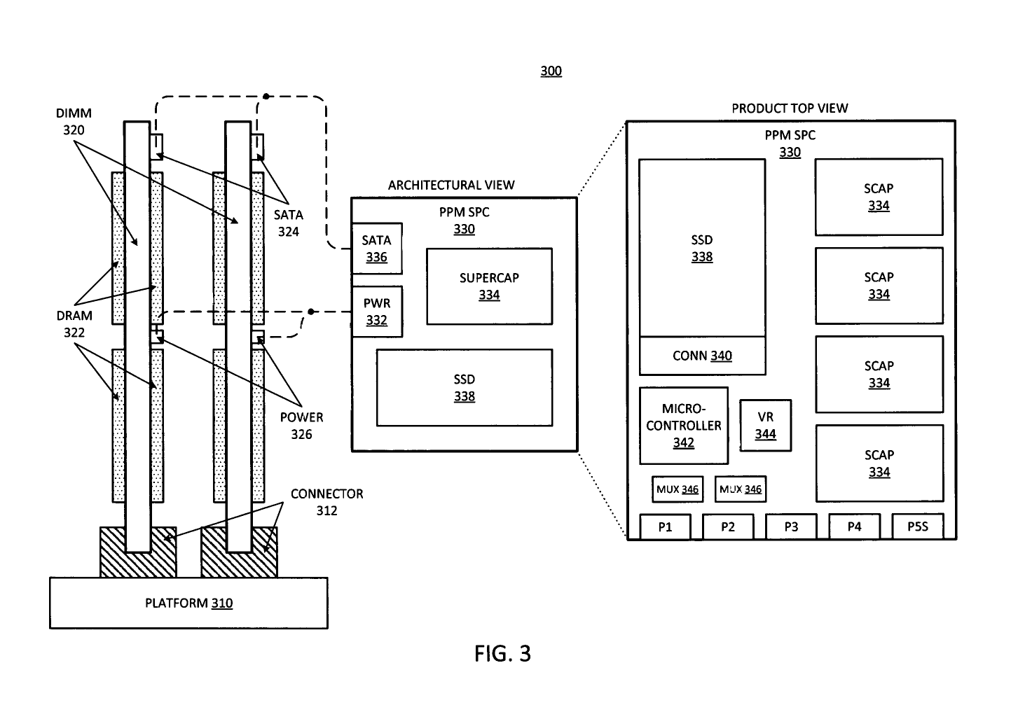

FIG. 3 is a block diagram of an embodiment of a power protected memory system platform. System 300 illustrates one embodiment of a platform view of a PPM system in accordance with system 100 and/or system 200. System 300 provides both an architectural view and a possible product top view of PPM SPC 330, which can be a power protection controller in accordance with any embodiment described herein.

DIMMs 320 are illustrated from the side, and connect to platform 310 via connectors 312. Platform 310 represents a hardware platform of a computing system in which system 300 is incorporated. Platform 310 can be a primary motherboard or PCB (printed circuit board) on which electronic components are mounted for a computing device. It will be understood that the vertical connection of DIMMs 320 to platform 310 is not limiting, and another connection alignment could be made. DIMMs 320 include DRAMs 322 disposed on each side, illustrating that the DIMM are not traditional NVDIMMs having storage on one side and protected memory resources on the other side. As illustrated, both DIMMs 320 are selected for protection, and thus, each includes a SATA connection 324, and a power connection 326.

Referring to the architectural view of PPM SPC 330, in one embodiment, PPM SPC 330 includes one or more power port connections 332, which connect to power connections 326 of DIMMs 320. The power connection enables super-cap 334 to provide temporary backup power when power supply power is not available. While not specifically shown, power supply power would typically be provided from a power supply that powers platform 310, and connects to DRAMs 322 via connector 312. Connectors 312 can be, for example, DIMM slots. Backup power connections 326 enable the DIMMs to continue to power DRAMs 322 to transfer memory contents to backup storage if power is lost.

In one embodiment, PPM SPC 330 includes SSD (solid state drive) 338 and/or includes control to couple to a nonvolatile storage to save memory contents in the event of a loss or interruption of power to DIMMs 320. In one embodiment, PPM SPC 330 includes one or more SATA ports 336 to couple to SATA ports 324 of DIMMs 320. SSD 338 provides one example embodiment of possible nonvolatile storage for system 300, but it will be understood that it is only an example, and is not limiting.

Referring to product top view of PPM SPC 330, the view illustrates an example embodiment of a possible product layout of a PPM SPC. The architectural view illustrates SATA connector(s) 346, which are illustrated as 5 SATA connection ports (P1 . . . P5S) in the product top view. It will be understood that the number of connections can be different depending on the implementation. While the product top view does not specifically illustrate the power connection 332, the top view provides a different perspective of super-cap (SCAP) devices 334. Reference in various illustrations and embodiments to a super-capacitor or super-cap can refer to multiple distinct devices coupled in parallel to function as a single super-cap unit. Thus, the top view of PPM SPC 330 illustrates 4 capacitor devices that are collectively super-cap 334. Other numbers of physical capacitor devices and other configurations are possible.

In one embodiment, PPM SPC 330 can be a device that mounts in a storage bay or mounts to another connector on platform 310. In one embodiment, PPM SPC 330 can be a device that is separate from platform 310, and connects to platform 310 via one or more connectors. In one embodiment, PPM SPC 330 includes SSD 338 mounted via connector (CONN) 340. In one embodiment, PPM SPC 330 includes microcontroller 342 and voltage regulator 344. Microcontroller 342 can provide the control logic to control the connection of DRAMs 322 to SSD 338. In one embodiment, PPM SPC 330 includes one or more multiplexer devices 346 located by microcontroller 332. Muxes 346 selectively connect one or more SATA ports to SSD 338 to enable microcontroller 342 to control the transfer of data from DRAMs 322 to nonvolatile backup storage.

As illustrated, PPM SPC 330 includes or includes access to a centralized backup energy source (super-cap 334) and a centralized nonvolatile backup storage (SSD 338). The backup energy source and nonvolatile backup storage are centralized in that they are not dedicated to a single DIMM, and are shared among backed up DIMMs. In one embodiment, system 300 can include a single power protected DIMM, instead of multiple DIMMs. In such a configuration, SSD 338 and super-cap 334 can be considered centralized in that they are still central to the system and an additional DIMM could be backed up based on the same backup resources.

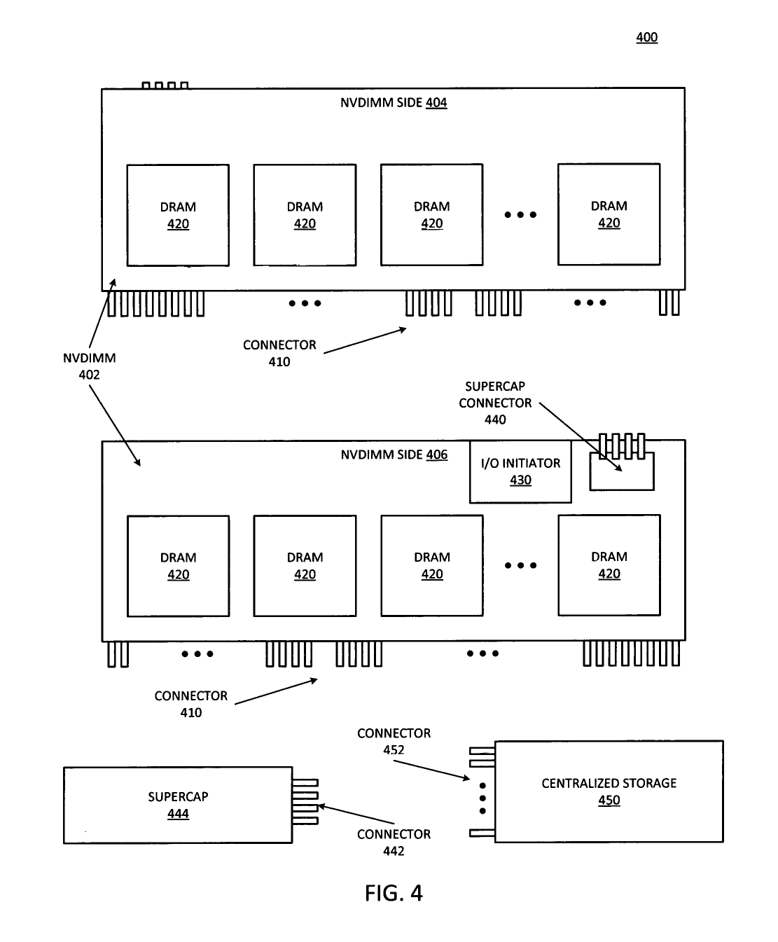

FIG. 4 is a block diagram of an embodiment of a DIMM (dual inline memory module) for a power protected memory system with centralized storage. System 400 provides one example of an NVDIMM in accordance with an embodiment of systems 100, 200, and/or 300. NVDIMM 402 is understood to have two sides, illustrated as NVDIMM side 404 and NVDIMM 406. There can be conventions that would suggest referring to one side as the “front” and the other side as the “back” of NVDIMM 402. However, it will be understood that NVDIMM 402 can be configured any way on either side 402 or 404, and thus, front and back conventions can simply be examples.

In one embodiment, NVDIMM side 404 represents a front side of NVDIMM 402 that includes multiple DRAM devices 420. NVDIMM side 406 is the reverse side or back side of NVDIMM 402, and also includes DRAM devices 420. Such a configuration of NVDIMM 402 is in contrast to traditional protection systems that would include DRAM devices on one side and a NAND storage device and FPGA (field programmable gate array) on the back of the NVDIMM. By removing the persistent storage from NVDIMM 402 itself, and centralizing the storage device in centralized storage 450, system 400 enables the backing storage media or storage device 450 to be shared across multiple NVDIMMs. It will be understood that centralized storage 450 for backup can be any nonvolatile media. One common medium in use is NAND flash, which can be contained on the platform or stored as a drive in a drive bay, for example.

As shown in system 400, side 406 includes an I/O (input/output) initiator 430, which can represent a microcontroller and/or other logic on NVDIMM 402. In one embodiment, I/O initiator 430 is or is part of an SPC in accordance with an embodiment described. In one embodiment, I/O initiator 430 manages I/O to transfer the contents of DRAM devices 420 from NVDIMM 402 to centralized storage 450. Side 406 also illustrates connector 440 to interface with super capacitor 444 to remain powered by the super-cap when power supply power is interrupted.

Connector 410 of NVDIMM 402 represents a connector to enable NVDIMM 402 to connect to a system platform, such as a DIMM slot. In one embodiment, centralized storage 450 includes connector 452, which enables the centralized storage to connect to one or more I/O interfaces or I/O buses that connect to DRAMs 420. Thus, DRAMs 420 can transfer their contents to centralized storage 450 on detection of a power failure. In one embodiment, super-cap 444 includes connector 442 to interface super-cap 444 to connector 440 of NVDIMM 402 and any other PPM DIMMs in system 400. In one embodiment, I/O initiator 430 is control logic on NVDIMM 402 that coordinates the transfer of data from DRAMs 420 to centralized storage 450 in conjunction with operation by a microcontroller of an SPC. In one embodiment, I/O initiator 430 is or is part of the SPC.

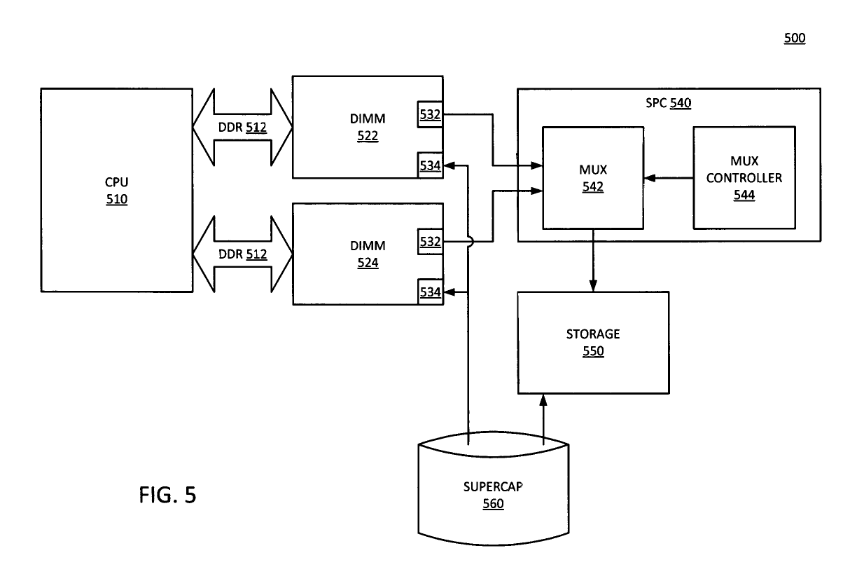

FIG. 5 is a block diagram of an embodiment of a power protected memory system with consolidated storage not on the NVDIMM. System 500 provides one example of a system in accordance with systems 100 and 200, and can use NVDIMMs in accordance with an embodiment of system 400. System 500 includes centralized or consolidated storage 550. By moving the storage media off the NVDIMM (e.g., DIMMs 522 and 524), multiple NVDIMMs can share storage capacity, which lowers the overall cost of the NVDIMM solution.

In one embodiment, DIMMs 522 and 524 are NVDIMMs, or DIMMs selected for power protection. DIMMs 522 and 524 include SATA ports 532 to couple to mux 542 for transferring contents to storage 550 in the event of a power failure. In one embodiment, SATA ports 532 also enable storage 550 to restore the image on DIMMs 522 and 524 when power is restored. In one embodiment, system 500 includes SPC 540 to control the copying of contents from NVDIMMs 522 and 524 to storage 550 on power failure, and to control the copying of contents from storage 550 back to NVDIMMs 522 and 524 upon restoration of power. In one embodiment, SPC 540 can represent a storage controller with storage media behind it to act as off-NVDIMM storage.

SPC 540 includes mux controller 544 and mux 542 to provide selective access by the NVDIMMs to storage 550 for purposes of backup and restoration of the backup. It will be understood that the pathway to transfer the data from NVDIMMs 522 and 524 to storage 550 can be a separate connection than a connection typically used on the platform to access the storage in the event of a page fault at a memory device. In one embodiment, the pathway is a separate, parallel pathway. In one embodiment, the memory can be restored when power is returned via the standard pathway. In one embodiment, the memory is restored from storage by the same pathway used to back the memory up. For example, CPU 510 represents a processor for system 500, which accesses memory of DIMMs 522 and 524 for normal operation via DDR (dual data rate) interfaces 512. Under normal operating conditions, a page fault over DDR 512 would result in CPU 510 accessing data from system nonvolatile storage, which can be the same or different storage from storage 550. The pathway to access the system storage can be the same or different from the pathway from DIMMs 522 and 524 to storage 550 for backup.

System 500 includes super-cap 560 or comparable energy storage device to provide temporary power when system power is lost. Super-cap 560 needs to be capable of holding an amount of energy that will enable the system to hold a supply voltage at a sufficient level for a sufficient period of time to allow the transfer of contents from the volatile memory on a system power loss condition. The size will thus be dependent on system configuration and system usage. System 500 includes a centralized storage 550, which is powered by super-cap 560 for backup.

In one embodiment, mux 542 of SPC 540 is multiplexing logic to connect multiple different channels of data to storage 550. In one embodiment, mux controller 544 includes a sequencer or sequencing logic that allows multiple NVDIMMs 522 and 524 to share the storage media. In one embodiment, sequencing logic in an SPC controller ensures that only one NVDIMM is able to write to the storage media at a given time.

In one embodiment, on system power failure, SPC 540 receives a signal indicating power failure, such as via a SAV signal. In response to the SAV signal or power failure indication, in one embodiment, SPC 540 arbitrates requests from I/O initiator circuitry on the DIM Ms to gain access to the storage controller to start a save operation to transfer memory contents to storage 550. In one embodiment, sequencing logic of mux controller 544 provides access to one NVDIMM at a time. Where arbitration is used, the NVDIMM that wins arbitration starts its save operation.

In one embodiment, once an NVDIMM completes its save, it relinquishes access to mux 542, which allows a subsequent NVDIMM to win its arbitration. Super-cap 560 provides sufficient power to allow all provisioned NVDIMMs 522 and 524 to complete their save operations. In one embodiment, each NVDIMM save operation is tagged with metadata that allows SPC 540 to associate the saved image with the corresponding NVDIMM. In one embodiment, on platform power on, NVDIMMs 522 and 524 can again arbitrate for access to storage 550 to restore their respective saved images.

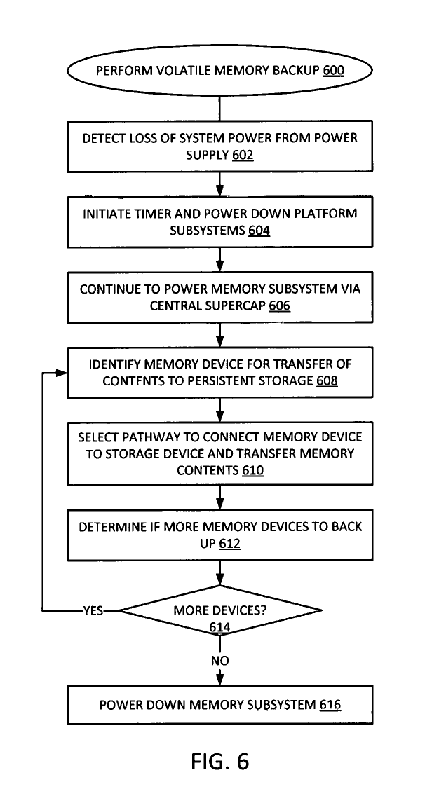

FIG. 6 is a flow diagram of an embodiment of a process for backing up volatile memory in response to an interruption of power supply power. Process 600 illustrates operations for content transfer of volatile memory to persistent storage. A computing system detects a loss of system power supplied from a power supply, 602. Without power, the system will shut down. In one embodiment, the loss of system power causes a controller on the computing system platform to initiate a timer and power down platform subsystems, 604. The platform includes a centralized energy source (e.g., a super capacitor) that provides temporary power when the power supply power is interrupted. In one embodiment, the timer can indicate how long the energy of the temporary supply is expected to last. The controller can make determinations on transferring memory content to storage based on the timer.

With power from the centralized backup energy source, the platform keeps the memory subsystem powered, 606. In one embodiment, the controller in the memory subsystem identifies one of multiple memory devices for transfer of its contents to persistent storage, 608. In one embodiment, all memory devices are backed up. In one embodiment, only selected memory devices are power protected and backed up. In one embodiment, the memory devices are selected individually (per memory device). In one embodiment, the memory devices are selected per DIMM, or per channel, or per rank. The selection allows the memory devices to connect to the centralized nonvolatile storage to transfer contents.

In one embodiment, the controller selects or activates a pathway (e.g., via a multiplexer) to connect the memory device (or DIMM, rank, channel, or other grouping) to the storage device, each in turn. The selection of memory devices can be on a priority basis, on an arbitration basis (such as via an initiator on the DIMM), on a preconfigured basis, or other basis. When connected, the memory device transfers its contents to the storage device for persistent storage, 610. The controller can determine if there are more selected memory devices to back up, 612. If there are more devices to back up and there is time/power remaining, 614 YES branch, the controller identifies the next memory device, 608. If there are no more devices to back up, 614 NO branch, the controller can power down the memory subsystem, 616.

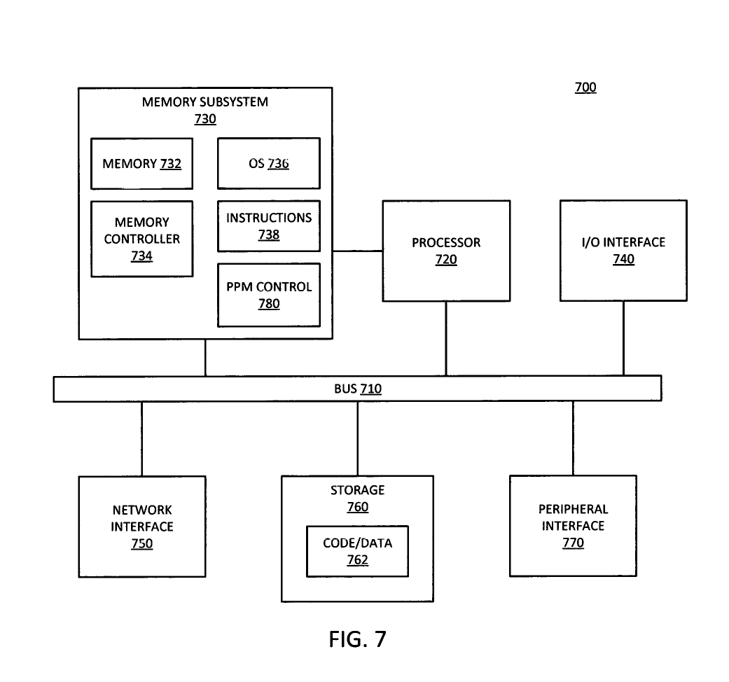

FIG. 7 is a block diagram of an embodiment of a computing system in which a power protected memory system can be implemented. System 700 represents a computing device in accordance with any embodiment described herein, and can be a laptop computer, a desktop computer, a server, a gaming or entertainment control system, a scanner, copier, printer, routing or switching device, or other electronic device. System 700 includes processor 720, which provides processing, operation management, and execution of instructions for system 700. Processor 720 can include any type of microprocessor, central processing unit (CPU), processing core, or other processing hardware to provide processing for system 700. Processor 720 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

Memory subsystem 730 represents the main memory of system 700, and provides temporary storage for code to be executed by processor 720, or data values to be used in executing a routine. Memory subsystem 730 can include one or more memory devices such as read-only memory (ROM), flash memory, one or more varieties of random access memory (RAM), or other memory devices, or a combination of such devices. Memory subsystem 730 stores and hosts, among other things, operating system (OS) 736 to provide a software platform for execution of instructions in system 700. Additionally, other instructions 738 are stored and executed from memory subsystem 730 to provide the logic and the processing of system 700. OS 736 and instructions 738 are executed by processor 720. Memory subsystem 730 includes memory device 732 where it stores data, instructions, programs, or other items. In one embodiment, memory subsystem includes memory controller 734, which is a memory controller to generate and issue commands to memory device 732. It will be understood that memory controller 734 could be a physical part of processor 720.

Processor 720 and memory subsystem 730 are coupled to bus/bus system 710. Bus 710 is an abstraction that represents any one or more separate physical buses, communication lines/interfaces, and/or point-to-point connections, connected by appropriate bridges, adapters, and/or controllers. Therefore, bus 710 can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (commonly referred to as “Firewire”). The buses of bus 710 can also correspond to interfaces in network interface 750.

System 700 also includes one or more input/output (I/O) interface(s) 740, network interface 750, one or more internal mass storage device(s) 760, and peripheral interface 770 coupled to bus 710. I/O interface 740 can include one or more interface components through which a user interacts with system 700 (e.g., video, audio, and/or alphanumeric interfacing). Network interface 750 provides system 700 the ability to communicate with remote devices (e.g., servers, other computing devices) over one or more networks. Network interface 750 can include an Ethernet adapter, wireless interconnection components, USB (universal serial bus), or other wired or wireless standards-based or proprietary interfaces.

Storage 760 can be or include any conventional medium for storing large amounts of data in a nonvolatile manner, such as one or more magnetic, solid state, or optical based disks, or a combination. Storage 760 holds code or instructions and data 762 in a persistent state (i.e., the value is retained despite interruption of power to system 700). Storage 760 can be generically considered to be a “memory,” although memory 730 is the executing or operating memory to provide instructions to processor 720. Whereas storage 760 is nonvolatile, memory 730 can include volatile memory (i.e., the value or state of the data is indeterminate if power is interrupted to system 700).

Peripheral interface 770 can include any hardware interface not specifically mentioned above. Peripherals refer generally to devices that connect dependently to system 700. A dependent connection is one where system 700 provides the software and/or hardware platform on which operation executes, and with which a user interacts.

In one embodiment, memory subsystem 730 includes volatile memory resources and PPM control 780, which represents logic to control a power protected memory in accordance with any embodiment described herein. PPM control 780 can include a microcontroller and a multiplexer. The microcontroller manages the operation of the PPM, and can be configured to manage the transfer of volatile memory contents to persistent storage in response to detecting a power failure (a loss or interruption of power supply power). PPM control 780 selectively connects memory resources (such as memory 732) to centralized storage (such as storage 760 or other storage not shown).

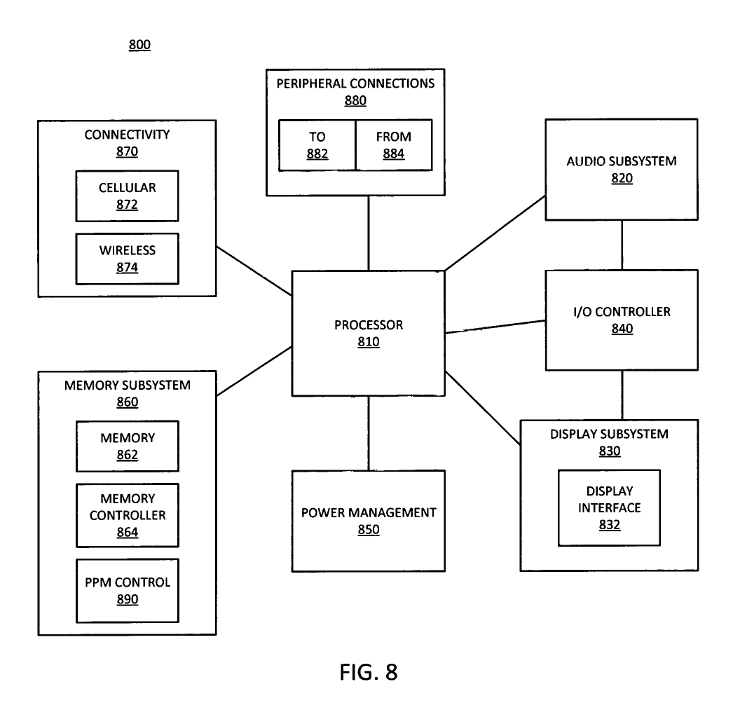

FIG. 8 is a block diagram of an embodiment of a mobile device in which a power protected memory system can be implemented. Device 800 represents a mobile computing device, such as a computing tablet, a mobile phone or smartphone, a wireless-enabled e-reader, wearable computing device, or other mobile device. It will be understood that certain of the components are shown generally, and not all components of such a device are shown in device 800.

Device 800 includes processor 810, which performs the primary processing operations of device 800. Processor 810 can include one or more physical devices, such as microprocessors, application processors, microcontrollers, programmable logic devices, or other processing means. The processing operations performed by processor 810 include the execution of an operating platform or operating system on which applications and/or device functions are executed. The processing operations include operations related to I/O (input/output) with a human user or with other devices, operations related to power management, and/or operations related to connecting device 800 to another device. The processing operations can also include operations related to audio I/O and/or display I/O.

In one embodiment, device 800 includes audio subsystem 820, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into device 800, or connected to device 800. In one embodiment, a user interacts with device 800 by providing audio commands that are received and processed by processor 810.

Display subsystem 830 represents hardware (e.g., display devices) and software (e.g., drivers) components that provide a visual and/or tactile display for a user to interact with the computing device. Display subsystem 830 includes display interface 832, which includes the particular screen or hardware device used to provide a display to a user. In one embodiment, display interface 832 includes logic separate from processor 810 to perform at least some processing related to the display. In one embodiment, display subsystem 830 includes a touchscreen device that provides both output and input to a user. In one embodiment, display subsystem 830 includes a high definition (HD) display that provides an output to a user. High definition can refer to a display having a pixel density of approximately 100 PPI (pixels per inch) or greater, and can include formats such as full HD (e.g., 1080p), retina displays, 4K (ultra high definition or UHD), or others.

I/O controller 840 represents hardware devices and software components related to interaction with a user. I/O controller 840 can operate to manage hardware that is part of audio subsystem 820 and/or display subsystem 830. Additionally, I/O controller 840 illustrates a connection point for additional devices that connect to device 800 through which a user might interact with the system. For example, devices that can be attached to device 800 might include microphone devices, speaker or stereo systems, video systems or other display device, keyboard or keypad devices, or other I/O devices for use with specific applications such as card readers or other devices.

As mentioned above, I/O controller 840 can interact with audio subsystem 820 and/or display subsystem 830. For example, input through a microphone or other audio device can provide input or commands for one or more applications or functions of device 800. Additionally, audio output can be provided instead of or in addition to display output. In another example, if display subsystem includes a touchscreen, the display device also acts as an input device, which can be at least partially managed by I/O controller 840. There can also be additional buttons or switches on device 800 to provide I/O functions managed by I/O controller 840.

In one embodiment, I/O controller 840 manages devices such as accelerometers, cameras, light sensors or other environmental sensors, gyroscopes, global positioning system (GPS), or other hardware that can be included in device 800. The input can be part of direct user interaction, as well as providing environmental input to the system to influence its operations (such as filtering for noise, adjusting displays for brightness detection, applying a flash for a camera, or other features). In one embodiment, device 800 includes power management 850 that manages battery power usage, charging of the battery, and features related to power saving operation.

Memory subsystem 860 includes memory device(s) 862 for storing information in device 800. Memory subsystem 860 can include nonvolatile (state does not change if power to the memory device is interrupted) and/or volatile (state is indeterminate if power to the memory device is interrupted) memory devices. Memory 860 can store application data, user data, music, photos, documents, or other data, as well as system data (whether long-term or temporary) related to the execution of the applications and functions of system 800. In one embodiment, memory subsystem 860 includes memory controller 864 (which could also be considered part of the control of system 800, and could potentially be considered part of processor 810). Memory controller 864 includes a scheduler to generate and issue commands to memory device 862.

Connectivity 870 includes hardware devices (e.g., wireless and/or wired connectors and communication hardware) and software components (e.g., drivers, protocol stacks) to enable device 800 to communicate with external devices. The external device could be separate devices, such as other computing devices, wireless access points or base stations, as well as peripherals such as headsets, printers, or other devices.

Connectivity 870 can include multiple different types of connectivity. To generalize, device 800 is illustrated with cellular connectivity 872 and wireless connectivity 874. Cellular connectivity 872 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), or other cellular service standards. Wireless connectivity 874 refers to wireless connectivity that is not cellular, and can include personal area networks (such as Bluetooth), local area networks (such as WiFi), and/or wide area networks (such as WiMax), or other wireless communication. Wireless communication refers to transfer of data through the use of modulated electromagnetic radiation through a non-solid medium. Wired communication occurs through a solid communication medium.

Peripheral connections 880 include hardware interfaces and connectors, as well as software components (e.g., drivers, protocol stacks) to make peripheral connections. It will be understood that device 800 could both be a peripheral device (“to” 882) to other computing devices, as well as have peripheral devices (“from” 884) connected to it. Device 800 commonly has a “docking” connector to connect to other computing devices for purposes such as managing (e.g., downloading and/or uploading, changing, synchronizing) content on device 800. Additionally, a docking connector can allow device 800 to connect to certain peripherals that allow device 800 to control content output, for example, to audiovisual or other systems.

In addition to a proprietary docking connector or other proprietary connection hardware, device 800 can make peripheral connections 880 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other type.

In one embodiment, memory subsystem 860 includes volatile memory resources. In one embodiment, memory subsystem 860 includes PPM control 890, which represents logic to control a power protected memory in accordance with any embodiment described herein. PPM control 890 can include a microcontroller and a multiplexer. The microcontroller manages the operation of the PPM, and can be configured to manage the transfer of volatile memory contents to persistent storage in response to detecting a power failure (a loss or interruption of power supply power). PPM control 890 selectively connects memory resources (such as memory 862) to centralized storage (not specifically identified, but which can be nonvolatile resources in memory subsystem 860 or other nonvolatile storage resources). It will be understood that due to the improvements in size of the PPM system described herein, in one embodiment, it can be implemented in a portable device 800.

In one aspect, a computing system with power protected memory includes: a backup energy source coupled in parallel with a power supply, the backup energy source to provide a temporary source of energy when power supply power is interrupted; a SATA (serial advanced technology attachment) storage device; and a memory subsystem including multiple volatile memory devices which do not maintain state when power is interrupted to the memory subsystem; a controller to detect that the power supply power is interrupted, and in response to detection that the power supply power is interrupted, selectively connect selected ones of the memory devices in turn to the storage device to transfer contents of the selected memory devices to the storage device.

In one embodiment, the backup energy source comprises a centralized super capacitor. In one embodiment, the backup energy source comprises a backup device in a drive bay of the computing system. In one embodiment, the storage device comprises a storage device dedicated to memory backup. In one embodiment, the storage device comprises part of general purpose storage in the computing system. In one embodiment, the backup energy source and the backup device comprise a backup card within the computing system. In one embodiment, the backup energy source and the backup device are integrated on a component that mounts in a drive bay of the computing system. In one embodiment, the memory devices comprise DRAM (dynamic random access memory) devices. In one embodiment, the memory devices comprise double data rate version 4 (DDR4) synchronous DRAM (SDRAM) devices. In one embodiment, the selected ones of the multiple memory devices comprises all the memory devices. In one embodiment, the controller is to selectively connect the memory devices to the storage device on a per memory controller basis. In one embodiment, the controller is to selectively connect the memory devices to the storage device on a per DIMM (dual inline memory module) basis. In one embodiment, the controller is to selectively connect the memory devices to the storage device on a per channel basis. In one embodiment, the controller comprises a controller of a nonvolatile DIMM (NVDIMM). In one embodiment, the controller comprises a registered clock driver an NVDIMM. In one embodiment, further comprising one or more of: at least one processor communicatively coupled to the memory subsystem; a network interface communicatively coupled to the computing system; or a display communicatively coupled to the computing system.

In one aspect, a hardware controller in a memory subsystem includes: a power input to receive power supply power when available, and to receive power from a backup energy source coupled in parallel with the power supply when power supply power is interrupted; an input port to receive a signal indicating that power supply power is interrupted; and control logic to identify selected memory devices in a memory subsystem to back up to a storage device in response to the received signal, including to connect the selected memory devices to the storage device to transfer the contents of the selected memory devices to the storage device.

In one embodiment, the backup energy source comprises a centralized super capacitor. In one embodiment, the storage device comprises a nonvolatile storage device in the memory subsystem. In one embodiment, the storage device comprises a nonvolatile storage device dedicated to memory backup. In one embodiment, the storage device comprises a nonvolatile storage allocated in general purpose storage in the computing system. In one embodiment, the selected ones of the multiple memory devices comprises all the memory devices. In one embodiment, further comprising: a programmable multiplexer to selectively connect the selected memory devices to the storage device in turn to transfer the contents of the selected memory devices to the storage device. In one embodiment, the multiplexer is to selectively connect the memory devices to the storage device on a basis of one of: per memory controller basis, per DIMM (dual inline memory module) basis, or per channel basis. In one embodiment, the controller comprises a controller of a nonvolatile DIMM (NVDIMM).

In one aspect, a method for backing up volatile memory includes: detecting an interruption to power supply power; continuing to power a memory subsystem with power from a temporary, backup energy source coupled; and selectively connecting multiple selected memory devices in turn to a SATA (serial advanced technology attachment) storage device to transfer contents of the selected memory devices to the storage device while powered by the backup energy source. In one aspect, the method is modified to perform operations in accordance with any one or more embodiments as described above with respect to the computing system. In one aspect, an apparatus for backing up volatile memory, includes means for performing operations to execute a method in accordance with any embodiment of the method.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A computing system with power protected memory, comprising:
a backup energy source coupled in parallel with a power supply, the backup energy source to provide a temporary source of energy when power supply power is interrupted;
a SATA (serial advanced technology attachment) storage device; and
a memory subsystem including
multiple volatile memory devices which do not maintain state when power is interrupted to the memory subsystem;
a controller to detect that the power supply power is interrupted, and in response to detection that the power supply power is interrupted, selectively connect selected ones of the memory devices in turn to the storage device to transfer contents of the selected memory devices to the storage device.

2. The computing system of claim 1, wherein the backup energy source comprises a centralized super capacitor.

3. The computing system of claim 1, wherein the storage device comprises a storage device dedicated to memory backup.

4. The computing system of claim 1, wherein the storage device comprises part of general purpose storage in the computing system.

5. The computing system of claim 1, wherein the memory devices comprise DRAM (dynamic random access memory) devices.

6. The computing system of claim 1, wherein the selected ones of the multiple memory devices comprises all the memory devices.

7. The computing system of claim 1, wherein the controller is to selectively connect the memory devices to the storage device on a per memory controller basis.

8. The computing system of claim 1, wherein the controller is to selectively connect the memory devices to the storage device on a per DIMM (dual inline memory module) basis.

9. The computing system of claim 1, wherein the controller is to selectively connect the memory devices to the storage device on a per channel basis.

10. The computing system of claim 1, further comprising one or more of:
at least one processor communicatively coupled to the memory subsystem;
a network interface communicatively coupled to the computing system; or
a display communicatively coupled to the computing system.

11. A hardware controller in a memory subsystem, comprising:
a power input to receive power supply power when available, and to receive power from a backup energy source coupled in parallel with the power supply when power supply power is interrupted;
an input port to receive a signal indicating that power supply power is interrupted; and
control logic to identify selected memory devices in a memory subsystem to back up to a storage device in response to the received signal, including to connect the selected memory devices to the storage device to transfer the contents of the selected memory devices to the storage device.

12. The controller of claim 11, wherein the backup energy source comprises a centralized super capacitor.

13. The controller of claim 11, wherein the storage device comprises a nonvolatile storage device in the memory subsystem.

14. The controller of claim 11, wherein the selected ones of the multiple memory devices comprises all the memory devices.

15. The controller of claim 11, further comprising:
a programmable multiplexer to selectively connect the selected memory devices to the storage device in turn to transfer the contents of the selected memory devices to the storage device.

16. The controller of claim 15, wherein the multiplexer is to selectively connect the memory devices to the storage device on a basis of one of: per memory controller basis, per DIMM (dual inline memory module) basis, or per channel basis.

17. A method for backing up volatile memory, comprising:
detecting an interruption to power supply power;
continuing to power a memory subsystem with power from a temporary, backup energy source coupled; and
selectively connecting multiple selected memory devices in turn to a SATA (serial advanced technology attachment) storage device to transfer contents of the selected memory devices to the storage device while powered by the backup energy source.

18. The method of claim 17, wherein the backup energy source comprises a centralized super capacitor.

19. The method of claim 17, wherein the storage device comprises a nonvolatile storage device outside the memory subsystem.

20. The method of claim 17, wherein the multiple selected memory devices comprises a selected subset of memory devices in the memory subsystem.

21. The method of claim 17, wherein selectively connecting the memory devices to the storage device comprises selectively connecting the memory devices to the storage device on a basis of one of: per memory controller basis, per DIMM (dual inline memory module) basis, or per channel basis.
